(19) United States
(12) Patent Application Publication
(10) Pub. No.: US 2006/0077133 A1
(43) Pub. Date: Apr. 13, 2006

(54) Plasma display device and driving method thereof

(76) Inventors: Jin-Ho Yang, Suwon-si (KR); Jin-Sung Kim, Suwon-si (KR); Tae-Seong Kim, Suwon-si (KR)

Correspondence Address: CHRISTIE, PARKER & HALE, LLP, PO BOX 7068, PASADENA, CA, 91109-7068, US

(21) Appl. No.: 11/248,716

(22) Filed: Oct. 11, 2005

(30) Foreign Application Priority Data
Oct. 11, 2004 (KR) 10-2004-0080867

(51) Int. Cl. G09G 3/28

(52) U.S. Cl. 345/68

(57) ABSTRACT

A power recovery circuit for a plasma display device and a driving method for the circuit. An inductor is coupled to form a resonance circuit and to generate a voltage difference between two electrodes of the same type that are coupled to the two terminals of a power recovery circuit. The resulting circuit allows formation of resonance between the two electrodes and power recovery from the panel capacitors formed in a PDP. Instead of hard-switching, the power recovery circuit is also used to maintain the voltage difference at the pre power recovery level after recovering power. As a result, power consumption is reduced when changing the voltage level of the two electrodes from the same voltage level to different voltage levels and vice versa. Further, elements having the same function are combined into a single element to simplify the circuit.

### CROSS-REFERENCE TO RELATED APPLICATION

This application claims priority to and the benefit of Korean Patent Application No. 10-2004-0080867 filed in the Korean Intellectual Property Office on Oct. 11, 2004, the entire content of which is incorporated herein by reference.

### BACKGROUND OF THE INVENTION

(a) Field of the Invention

The present invention relates to a plasma display device and a driving method thereof.

(b) Description of the Related Art

Recently, flat panel displays, such as liquid crystal displays (LCDs), field emission displays (FEDs), and plasma display devices have been actively developed. The plasma display devices are advantageous over the other flat panel displays in regards to their high luminance, high luminous efficiency, and wide viewing angle. Accordingly, plasma display devices are being highlighted as replacements for conventional cathode ray tubes (CRTs) for large-screen displays of more than 40 inches.

Plasma display devices are flat panel displays that use plasma generated by gas discharge to display characters or images and include plasma display panels (PDPs). Depending on size, the PDPs include more than several hundreds of thousands to millions of pixels arranged in the form of a matrix. The PDPs are classified into a direct current (DC) type and an alternating current (AC) type depending on the pattern of waveforms of driving voltages applied to a panel and the discharge cell structure of the panel. A DC PDP has electrodes exposed to a discharge space without insulation, thereby causing a current to directly flow through the discharge space during application of a voltage to the DC PDP. The DC PDP has a disadvantage in that it requires a resistor for limiting the current. On the other hand, an AC PDP has electrodes covered with a dielectric layer that forms a natural capacitance component to limit the current and protects the electrodes from the impact of ions during discharge. As a result, the AC PDP lasts longer than the DC PDP.

FIG. 1 shows an exemplary electrode arrangement diagram of a plasma display device where electrodes of the PDP are arranged in an (n×m) matrix format. Address electrodes A₁ to Aₘ are arranged in a column direction, and scan electrodes Y₁ to Yₙ and sustain electrodes X₁ to Xₙ are arranged in pairs in a row direction. A method for driving the AC PDP can be expressed by temporal operation periods, including a reset period, an address period, a sustain period, and an erase period. During the reset period, the discharge cells are reset in order to stably perform a consequent address operation on the discharge cells. During the address period, an address voltage is applied to the addressed discharge cells to accumulate wall charges on the discharge cells. Application of the address voltage selects the discharge cells that are turned on and distinguishes the discharge cells that are not turned on. During the sustain period, a discharge for actually displaying images on the addressed discharge cells is performed by applying a sustain discharge pulse. During the erase period, wall charges of the cells are reduced to terminate the sustain discharge. A certain amount of capacitance develops on the PDP that is due to the existence of a discharge space between each pair of scan and sustain electrodes, and another discharge space between a surface on which the address electrodes are formed and a surface on which the scan and sustain electrodes are formed. These discharge spaces operate as capacitive loads and are referred to as panel capacitors. Therefore, in order to apply waveforms for a sustain discharge during the sustain period, in addition to power required for a sustain discharge, reactive power used by the panel capacitors must also be provided. A circuit for recovering the reactive power and reusing it is referred to as a power recovery circuit or a sustain discharge circuit.

Conventional power recovery circuits include a serial LC resonance power recovery circuit (U.S. Pat. No. 5,081,400 to Weber et al.), a parallel LC resonance power recovery circuit (U.S. Pat. No. 5,670,974 to Ohba et al.), a serial LCLC resonance power recovery circuit (U.S. Pat. No. 6,072,447 to Noborio), and a serial CLC resonance power recovery circuit (U.S. Pat. No. 6,538,627 to Whang et al.). The serial LC resonance power recovery circuit of Weber et al. uses an additional capacitor to provide a middle level of a sustain discharge voltage, and the other three power recovery circuits use the panel capacitor, without any external capacitor.

FIG. 2 shows how the scan electrodes Y1 to Yn and the sustain electrodes X1 to Xn relate to a power recovery circuit 30 in the case of the conventional parallel LC resonance. Power recovery generally relates to a sustain pulse applied between the scan and sustain electrodes during the sustain period. The scan electrodes Y1 to Yn and the sustain electrodes X1 to Xn are coupled to a power recovery circuit 30. The power recovery circuit 30 includes a sustain discharge unit 32, a power recovery unit 34, and a sustain discharge unit 36. The sustain discharge unit 32 includes switches for switching a sustain discharge voltage to the scan electrodes Y1 to Yn. The power recovery unit 34 includes an inductor (a coil), a switch, and a diode. The sustain discharge unit 36 includes switches for switching a sustain discharge voltage to the sustain electrodes X1 to Xn.

FIG. 3 shows how the scan electrodes Y1 to Yn and the sustain electrodes X1 to Xn relate to first and second power recovery circuits 40, 40′ in the case of the conventional serial CLC resonance. The scan electrodes Y1 to Yn and the sustain electrodes X1 to Xn are coupled to odd-line electrodes VO1 and V02 and even-line electrodes VE1 and VE2. The odd-numbered scan electrodes Y1, Y3 . . . Yn-1 are coupled to the odd-line electrode VO1. The odd-numbered sustain electrodes X1, X3 . . . Xn-1 are coupled to the odd-line electrode VO2. The even-numbered scan electrodes Y2, Y4 . . . Yn are coupled to the even-line electrode VE1. And, the even-numbered sustain electrodes X2, X4 . . . Xn are coupled to the even-line electrode VE2. The first power recovery circuit 40 includes a first sustain discharge unit 42 including switches for switching a sustain discharge voltage to the electrode VO1, a first power recovery unit 44 including an inductor (a coil), a switch, and a diode, and a first sustain discharge unit 46 including switches for switching a sustain discharge voltage to the even-line electrode VE1. Similarly, the second power recovery circuit 40′ includes a second sustain discharge unit 42′, a second power recovery unit 44′, and a second sustain discharge unit 46′ corresponding to those of the first power recovery circuit 40.

In the serial LCLC resonance power recovery circuit (not shown), the position shown in FIG. 3 for the even-line electrode VE1 coupled to the even scan electrodes is exchanged with the position of the even-line electrode VE2 coupled to the even sustain electrodes. As shown in FIG. 2 and FIG. 3 for the parallel LC resonance and the serial CLC resonance, and as may be deduced for the serial LCLC resonance (not shown), the power recovery circuits each include two sustain discharge units and one power recovery unit. A single circuit includes all three units corresponding to a power recovery circuit.

The power recovery circuits 40, 40′ shown in FIG. 3 recover the power between an odd-line electrode VO1, VO2 and its corresponding even-line electrode VE1, VE2 by LC resonance. Therefore, it is impossible to recover power when the voltage at the odd-line electrode VO1 is equal to the voltage at the corresponding even-line electrode VE1 and power can be recovered only when the voltages at the two electrodes are different. This causes a serious waveform design problem. For example, when the odd-line electrode VO1 and the corresponding even-line electrode VE1 have the same potential after the address period, a voltage must be applied to one of the electrodes through hard switching during the sustain period. A steep variation in the voltage that occurs during hard switching, undesirably consumes reactive power and increases noise. These problems are common among the parallel LC, the serial LCLC, and the serial CLC resonance power recovery circuits.

A need, therefore, exists for development of driving circuits and methods that reduce the reactive power used by the driving circuits of the PDP in a plasma display device.

### SUMMARY OF THE INVENTION

Embodiments of the present invention provide a plasma display device and a driving method for the plasma display device having advantages of reducing power consumption.

An exemplary plasma display device according to an embodiment of the present invention includes a panel and a driving circuit. The panel includes a plurality of first electrodes and second electrodes. The driving circuit uses a first panel capacitor and a second panel capacitor formed at the first electrode and the second electrode to form a charge and discharge path between the first electrode and the second electrode. The driving circuit includes a first inductor, a first switch, a second inductor, a second switch, a third switch, a fourth switch, a fifth switch, and a sixth switch. The first inductor has a first terminal coupled to the first electrode. The first switch is coupled between a second terminal of the first inductor and the second electrode, and switches a charge path from the first electrode to the second electrode. The second inductor has a first terminal coupled to the second electrode. The second switch is coupled between a second terminal of the second inductor and the first electrode, and switches a charge path from the second electrode to the first electrode. The third switch is coupled between the second terminal of the second inductor and a first power source for supplying a first voltage, and switches a charge path from the first power source to the second electrode. The fourth switch is coupled between the second terminal of the second inductor and the first power source, and switches a path for discharging the second electrode. The fifth switch is coupled between the second terminal of the first inductor and the first power source, and switches a charge path from the first power source to the first electrode. The sixth switch is coupled between the second terminal of the first inductor and the first power source, and switches a path for discharging the first electrode.

When the third switch is turned on, a current path including the first power source, the third switch, the second inductor, and the second electrode is formed, and the voltage at the second electrode is increased from a second voltage that is less than a first voltage to a third voltage that is greater than the first voltage, and when the fourth switch is turned on, a current path including the second electrode, the second inductor, the fourth switch, and the first power source is formed, and the voltage at the second electrode is decreased from the third voltage to the second voltage. When the fifth switch is turned on, a current path including the first power source, the fifth switch, the first inductor, and the first electrode is formed, and the voltage at the first electrode is increased from a second voltage that is less than a first voltage to a third voltage that is greater than the first voltage, and when the sixth switch is turned on, a current path including the first electrode, the first inductor, the sixth switch, and the first power source is formed, and the voltage at the first electrode is decreased from the third voltage to the first voltage.

In a further embodiment, provided is a plasma display device driving method for using a driving circuit, a first panel capacitor, and a second panel capacitor, and forming a charge/discharge path between a first electrode and a second electrode, the driving circuit including a first inductor having a first terminal coupled to the first electrode and a second inductor having a first terminal coupled to the second electrode, the first panel capacitor being formed at the first electrode, and the second panel capacitor being formed at the second electrode. In the method, (a) a first switch coupled to a second terminal of the second inductor is turned on in an early stage of a sustain period to change voltage levels of the first electrode and the second electrode from a same voltage level to different voltage levels; and (b) a second switch coupled between a second terminal of the first inductor and the second electrode and a third switch coupled between a second terminal of the second inductor and the first electrode are alternately turned on to form a charge/discharge path between the first electrode and the second electrode.

### BRIEF DESCRIPTION OF THE DRAWINGS

FIG. 1 shows a typical electrode arrangement of a plasma display device.

FIG. 2 shows coupling of scan electrodes and sustain electrodes to a power recovery circuit in a conventional parallel LC resonance power recovery system.

FIG. 3 shows coupling of scan electrodes and sustain electrodes to power recovery circuits in a conventional serial CLC resonance power recovery system.

FIG. 4 shows a plasma display device according to an exemplary embodiment of the present invention.

FIG. 5 shows a first power recovery circuit according to an exemplary embodiment of the present invention.

FIG. 6 shows a first driving timing diagram of a power recovery circuit according to an exemplary embodiment of the present invention.

FIGS. 7A, 7B, 7C, 7D, 7E, 7F, 7G, 7H, and 7I show current paths occurring during different modes in the first driving timing diagram of FIG. 6.

FIG. 8 shows a second driving timing diagram of a power recovery circuit according to an exemplary embodiment of the present invention.

FIGS. 9A, 9B, 9C, and 9D show current paths occurring during different modes in the second driving timing diagram of FIG. 8.

FIG. 10 shows waveforms during the sustain period having the combined voltage waveforms of FIG. 6 and FIG. 8.

FIG. 11 shows a second power recovery circuit according to an exemplary embodiment of the present invention.

FIG. 12 shows a third power recovery circuit according to an exemplary embodiment of the present invention.

FIG. 13A shows another embodiment for a clamping-VC connector circuit of the power recovery circuit of FIG. 11, and FIG. 13B shows another embodiment for a clamping-VC connector circuit of the power recovery circuit of FIG. 12.

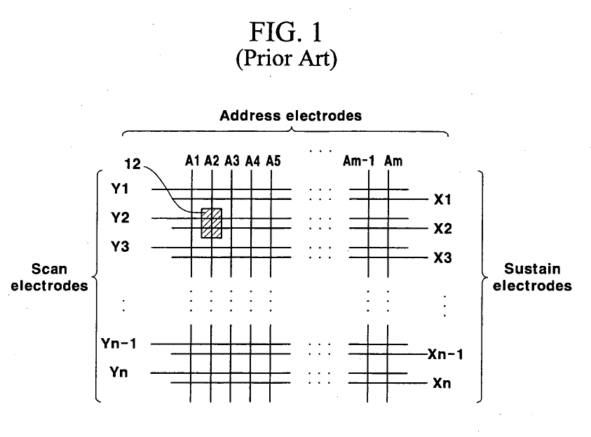

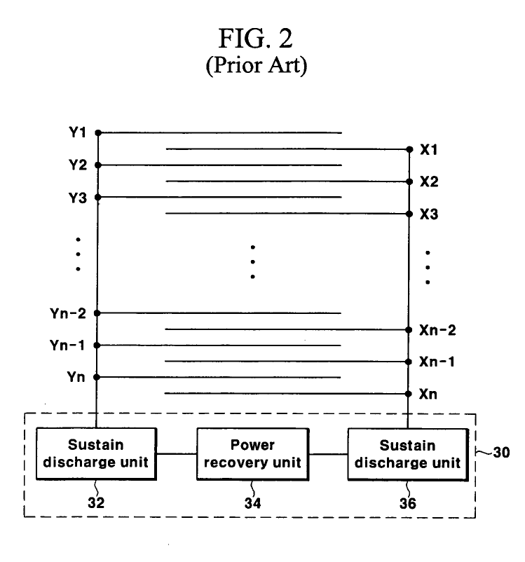

### DETAILED DESCRIPTION OF THE EMBODIMENTS

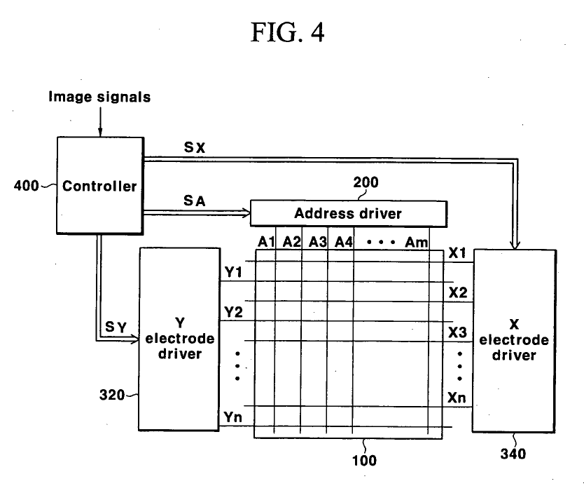

FIG. 4 shows a plasma display device according to an embodiment of the present invention. As shown in FIG. 4, the plasma display device includes a PDP 100, an address driver 200, a scan electrode (Y electrode) driver 320, a sustain electrode (X electrode) driver 340, and a controller 400. The PDP 100 includes a plurality of address electrodes A1 to Am in the column direction, and scan electrodes Y1 to Yn and sustain electrodes X1 to Xn in the row direction. The address driver 200 receives an address driving control signal S_{A} from the controller 400, and applies a display data signal for selecting a discharge cell to be displayed to the address electrodes. The Y electrode driver 320 and the X electrode driver 340 respectively receive a Y electrode driving signal S_{Y} and an X electrode driving signal S_{X} from the controller 400, and apply the driving signals to the X electrodes and the Y electrodes. The controller 400 receives an external image signal, generates an address driving control signal S_{A}, a Y electrode driving signal S_{Y} and an X electrode driving signal S_{X}, and transmits these signals to the address driver 200, the Y electrode driver 320, and the X electrode driver 340, respectively.

The Y electrode driver 320 and the X electrode driver 340 each include a power recovery circuit for recovering reactive power and using this power. Configuration and operation of the X electrode driver 340 are similar to those of the power recovery circuit in the Y electrode driver 320. Hence, only the configuration and operation of the power recovery circuit of the Y electrode driver is described. Further, switching timing between the X and Y electrodes for providing a sustain discharge voltage is only slightly different.

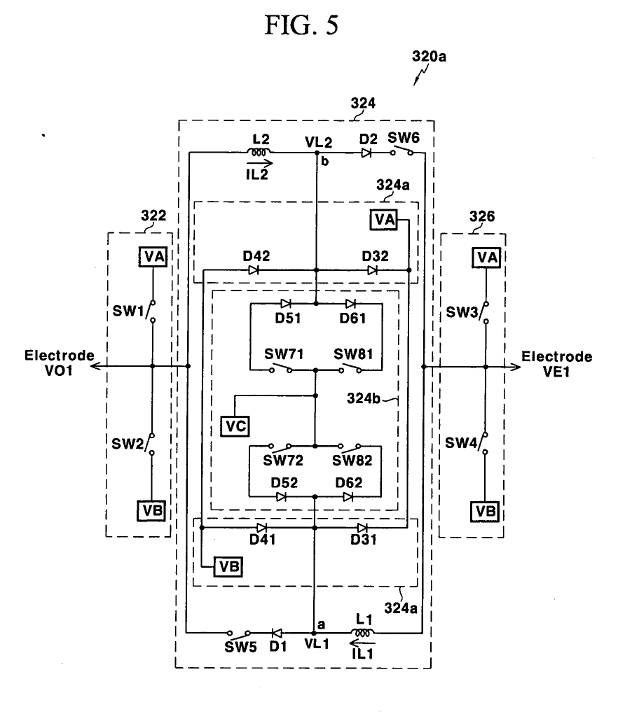

Referring now to FIG. 5, a first power recovery circuit 320a according to an exemplary embodiment of the present invention is shown. The first power recovery circuit 320a is a serial CLC resonance type power recovery circuit, and is coupled to the odd-line electrode VO1 and the even-line electrode VE1 that are coupled to the Y electrodes Y1 to Yn. Pairs of the odd-line electrodes VO1 and the odd-line electrodes VO2, that are coupled to the X electrodes X1 to Xn, form a panel capacitor. Pairs of the even-line electrodes VE1 and VE2 also form a panel capacitor.

As shown in FIG. 5, the first power recovery circuit 320a includes first and second sustain discharge units 322, 326 and a power recovery unit 324. The first and second sustain discharge units 322, 326 use clamping power sources VA and VB to increase a voltage at the electrode VO1 or VE1 to a final voltage when the voltage at the electrode is increased or decreased to a predetermined level. The power recovery unit 324 establishes resonance between the electrodes VE1 and VO1 and has a first resonance path formed from the electrode VE1 to the electrode VO1 and a second resonance path formed from the electrode VO1 to the electrode VE1. The power recovery unit 324 includes a damper 324a and a first VC connector 324b. The damper 324a is for clamping voltages VL1 and VL2. The first VC connector 324b, according to a first embodiment for a VC connector, is for recovering power when the voltage levels of the electrodes VO1 and VE1 are varied from the same level to different levels and from different levels back to the same level.

The first sustain discharge unit 322 includes switches SW1 and SW2 for switching the power sources VA and VB, and a node formed between the switches SW1 and SW2 is coupled to the electrode VO1. The second sustain discharge unit 326 includes switches SW3 and SW4 for switching the power sources VA and VB, and a node formed between the switches SW3 and SW4 is coupled to the electrode VE1. In the example shown, the switches SW1 and SW3 are coupled to the power source VA, and the switches SW2 and SW4 are coupled to the power source VB. A voltage difference VA-VB between the power sources VA and VB corresponds to a sustain discharge voltage Vs applied to the Y electrode during the sustain period, and the voltage of the power source VA is generally set to be higher than that of the power source VB.

The power recovery unit 324 includes an inductor L1, a diode D1, and a switch SW5 for forming the first resonance path from the electrode VE1 to the electrode VO1, and an inductor L2, a diode D2, and a switch SW6 for forming the second resonance path from the electrode VO1 to the electrode VE1. A first terminal of the inductor L1 is coupled to the electrode VE1, and a second terminal thereof is coupled to an anode of the diode D1. A cathode of the diode D1 is coupled to a first terminal of the switch SW5 for switching the first resonance path, and a second terminal of the switch SW5 is coupled to the electrode VO1. A first terminal of the inductor L2 is coupled to the electrode VO1, and a second terminal thereof is coupled to an anode of the diode D2. A cathode of the diode D2 is coupled to a first terminal of the switch SW6 for switching the second resonance path, and a second terminal of the switch SW6 is coupled to the electrode VE1. A positive (+) direction of a current IL1 flowing through the inductor L1 is given to be from the electrode VE1 to the electrode VO1, and a positive (+) direction of a current IL2 flowing through the inductor L2 is given to be from the electrode VO1 to the electrode VE1 in FIG. 5.

The power recovery unit 324 includes the clamper 324a for respectively clamping a voltage VL1 at a node “a” formed between the inductor L1 and the diode D1, and a voltage VL2 at a node “b” formed between the inductor L2 and the diode D2. The clamper 324a includes diode D31, D32, D41, and D42. The diode D31 has an anode coupled to the node “a” and a cathode coupled to the power source VA to maintain the voltage VL1 at the node “a” to not greater than the voltage of the power source VA. The diode D32 has an anode coupled to the node “b” and a cathode coupled to the power source VA to maintain the voltage VL2 at the node “b” to not greater than the voltage of the power source VA. The diode D41 has a cathode coupled to the node “a” and an anode coupled to the power source VB to maintain the voltage VL1 at the node “a” to not less than the voltage of the power source VB. The diode D42 has a cathode coupled to the node “b” and an anode coupled to the power source VB to maintain the voltage VL2 at the node “b” to not less than the voltage of the power source VB.

The first VC connector 324b includes switches SW71, SW72, SW81, and SW81, diodes D51, D52, D61, and D62, and power source VC. The switches SW72 and SW71 are for controlling directions of currents respectively flowing from the power source VC to the nodes “a” and “b”. The diodes D52 and D51 are for respectively intercepting reverse currents from the nodes “a” and “b” back to the power source VC. The switches SW82 and SW81 are for controlling directions of currents respectively flowing from the nodes “a” and “b” to the power source VC. The diodes D62 and D61 are for respectively intercepting reverse currents from the power source VC back to the nodes “a” and “b”. The power source VC has a power recovery capacitor Cr (not shown) and supplies a predetermined voltage corresponding to a voltage given between the voltage levels of the power sources VA and VB.

In the first VC connector 324b, the diodes D52 and D62 are coupled in series to the switches SW72 and SW82, respectively. The diode-switches D52-SW72 and D62-SW82 are coupled in parallel to each other and in between the node “a” and the power source VC. The diodes D51 and D61 are respectively coupled in series to the switches SW71 and SW81. The diodes-switches D51-SW71 and D61-SW81 are coupled in parallel to each other and in between the node “b” and the power source VC. When the switch SW72 is turned on, a resonance current flows in the negative current direction of the inductor L1, opposite the direction of IL1, to increase the voltage level of the electrode VE1 from the voltage VB to a voltage near the voltage VA. When the switch SW82 is turned on, a resonance current flows in the positive current direction of the inductor L1 to decrease the voltage level of the electrode VE1 from the voltage VA to a voltage near the voltage VB. Also, when the switch SW71 is turned on, a resonance current flows in the negative current direction of the inductor L2 to increase the voltage level of the electrode VO1 from the voltage VB to a voltage near the voltage VA. When the switch SW81 is turned on, a resonance current flows in the positive current direction of the inductor L2 to decrease the voltage level of the electrode VO1 from the voltage VA to a voltage near the voltage VB. Therefore, the switches SW72 and SW82 are used to control the voltage level of the electrode VE1, and the switches SW71 and SW81 are used to control the voltage level of the electrode VO1.

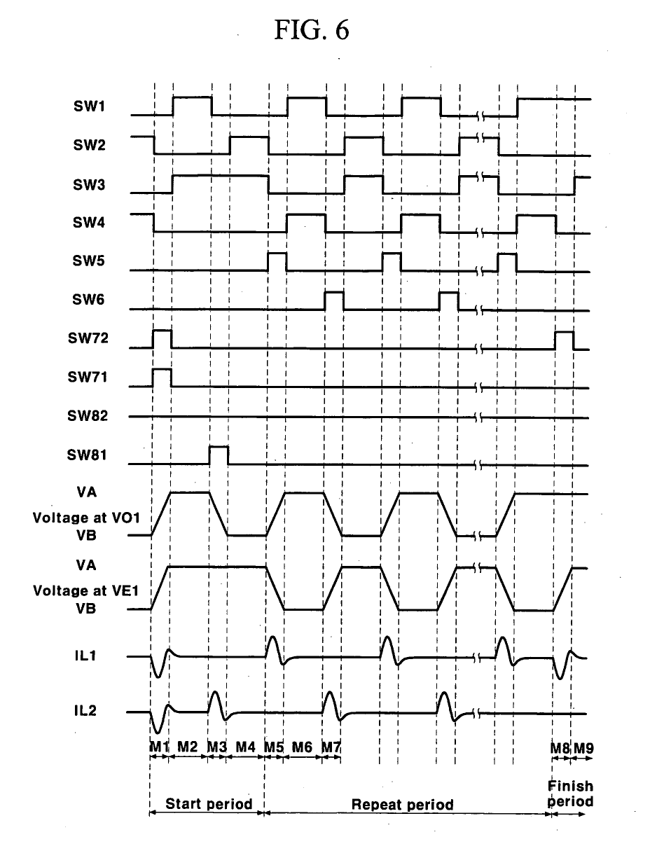

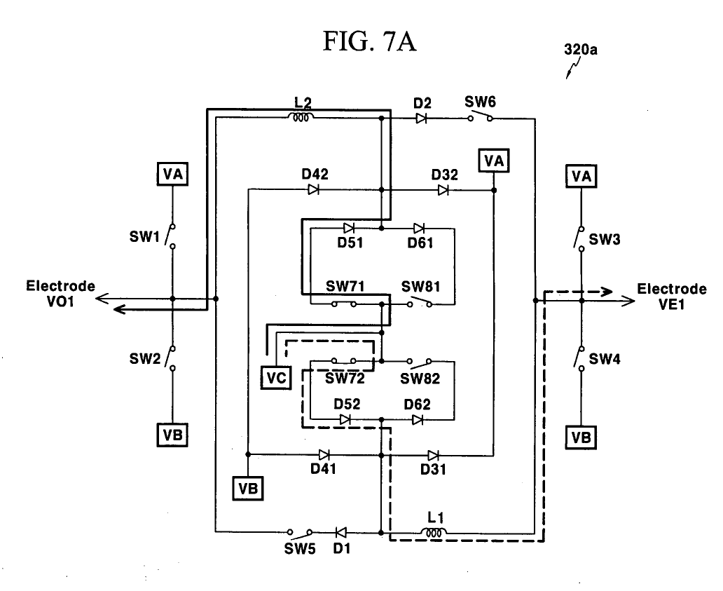

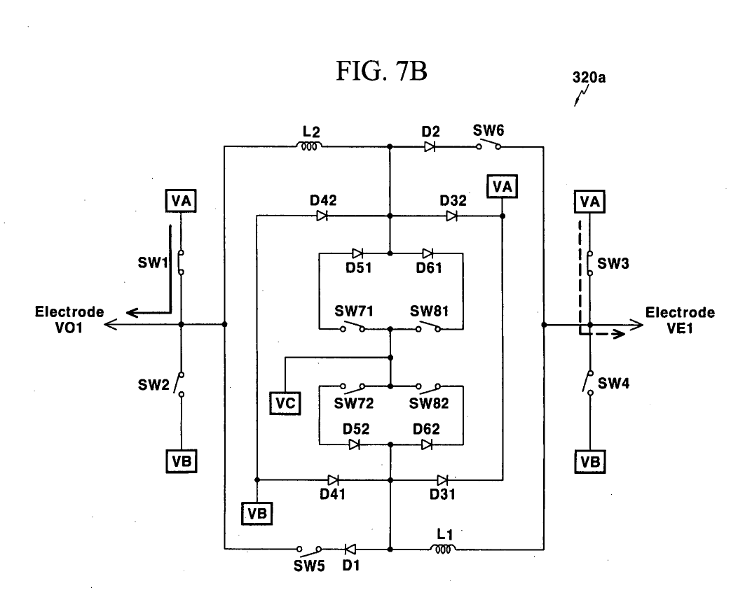

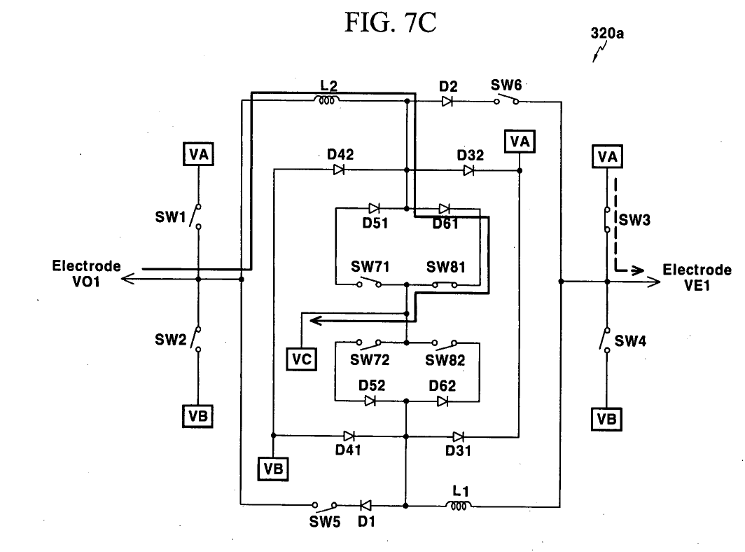

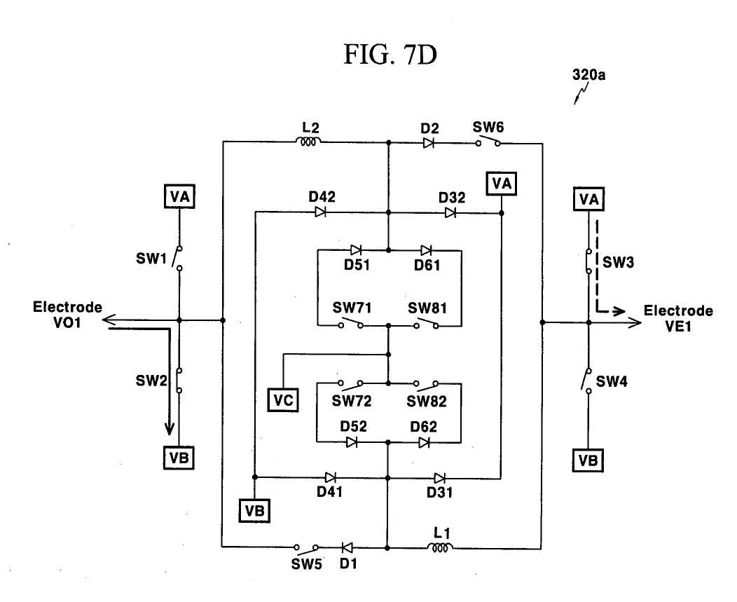

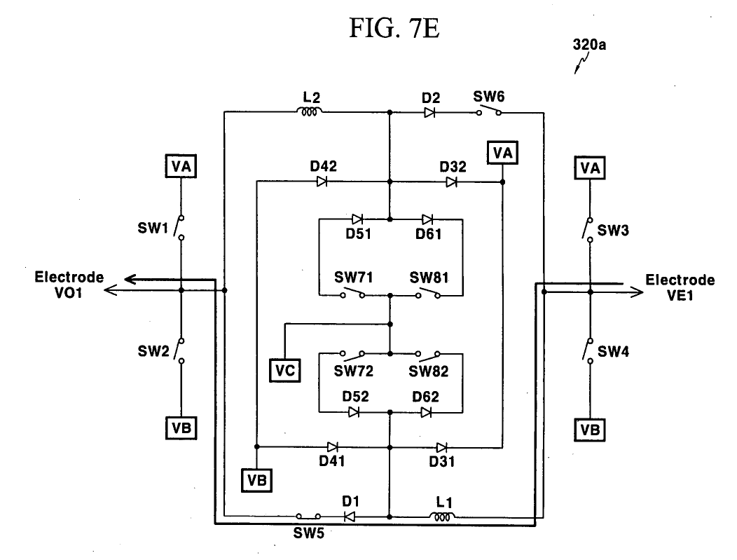

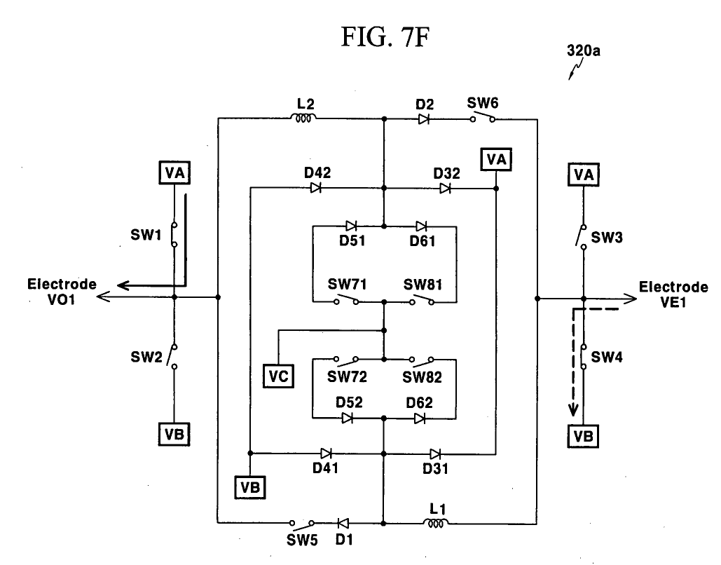

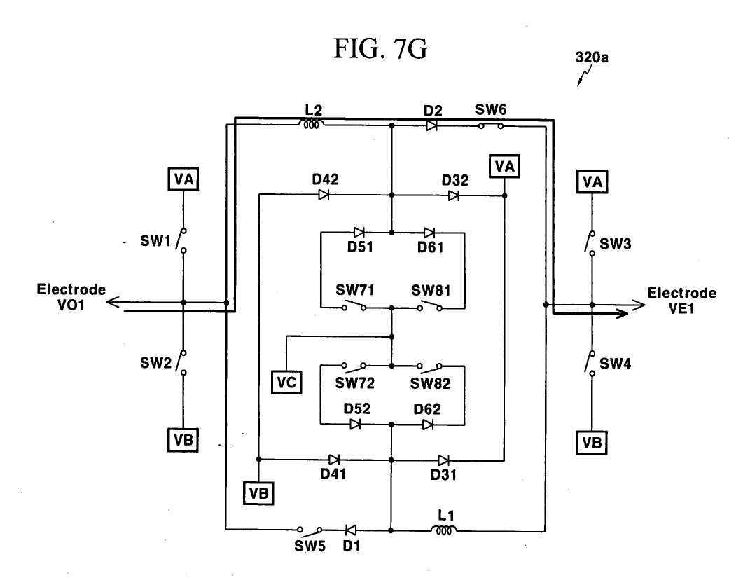

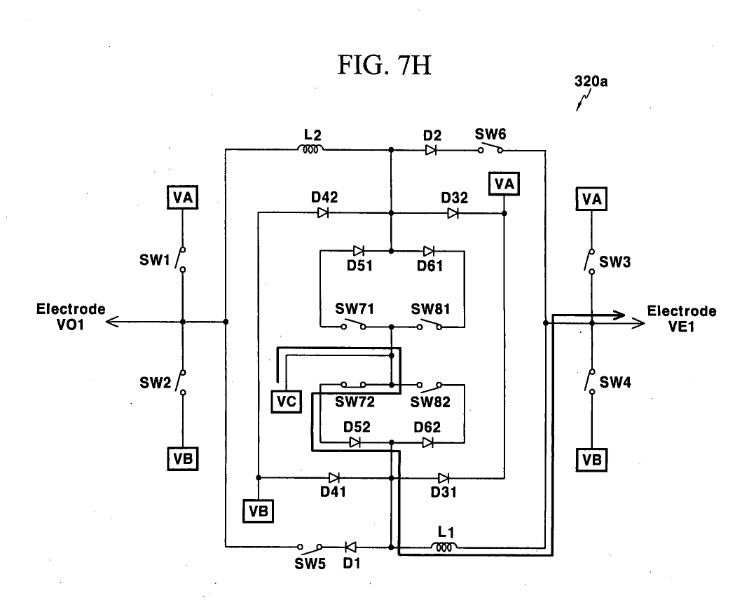

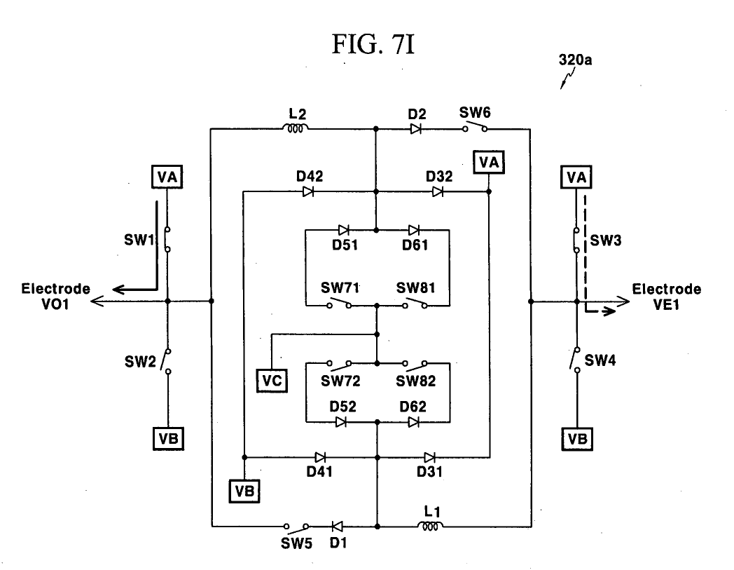

A method for power recovery when the voltage levels of the electrodes VO1 and VE1 are controlled to be at VA in the termination stage of the sustain period while the voltage levels of the electrodes VO1 and VE1 are controlled to be at VB in the earlier stage of the sustain period is described with reference to FIG. 6 and FIGS. 7A to 7I.

FIG. 6 shows a first driving timing diagram of a power recovery circuit according to an exemplary embodiment of the present invention. The exemplary driving waveforms of FIG. 6 pertain to the power recovery circuit of a Y electrode driver, for example, to the power recovery circuit of the Y electrode driver 320a. A similar set of driving waveforms may be used for the power recovery circuit of a X electrode driver, for example, to the power recovery circuit of the X electrode driver 340.

The voltage waveforms of the voltages applied at VO1 and VE1, the current waveforms IL1 and IL2 that are respectively flowing through the inductors L1 and L2, and the on or off states of the switches SW1, SW2, SW3, SW4, SW5, SW6, SW72, SW71, SW82, and SW81 are shown in FIG. 6. The time line of FIG. 6 corresponds to a sustain period that is divided into a start period, a repeat period, and a finish period. The voltages at the electrodes VO1 and VE1 vary between VA and VB. During the start period, the voltages at the electrodes VO1 and VE1 start out as equal but the voltage at VO1 is later changed to different levels. During the repeat period, when power is recovered between the electrodes VO1 and VE1, these two voltages have opposite levels. During the finish period, the voltage levels of the two electrodes are changed back to the same level.

It is assumed that the electrodes VO1 and VE1 have the voltage level of VB before the operation according to the first embodiment of the present invention is performed, and the power recovery capacitor Cr of power source VC is charged with a voltage (not shown) which is half the summed voltage levels of VA and VB. Accordingly, before the start period, the switches SW2 and SW4 are turned on to keep the electrodes VO1 and VE1 at the voltage level of VB. When, at the beginning of the start period, the switches SW2 and SW4 are turned off, the voltages at the electrodes VO1 and VE1 are increased from the voltage level of VB to the voltage level of VA by LC resonance.

As shown in FIG. 6, the start period is divided into four modes, including mode one (M1), mode two (M2), mode three (M3), and mode four (M4). The repeat period includes mode five (M5), mode six (M6), and mode seven (M7) that are repeated during this period. The finish period includes mode eight (M8) and mode nine (M9).

The switches SW71 and SW72 are turned on during M1. As a result, as shown in FIG. 7A, a current path including the power source VC, the switch SW71, the diode D51, the inductor L2, and the electrode VO1 is formed that generates LC resonance, and the voltage level of the electrode VO1 accordingly rises to the voltage level of VA. Another current path including the power source VC, the switch SW72, the diode D52, the inductor L1, and the electrode VE1 is also formed that generates LC resonance, and the voltage level of the electrode VE1 accordingly rises to the voltage level of VA. That is, as shown in FIG. 6, the voltages at the electrodes VO1 and VE1 rise to the voltage of VA during M1.

During M2, the switches SW1 and SW3 are turned on. As shown in FIG. 7B, currents flow from the power source VA to the electrodes VO1 and VE1 so that the voltages at the electrodes VO1 and VE1 remain at the voltage of VA. At the end of M2, the voltage at the electrode VE1 is maintained at the voltage of VA and the voltage at the electrode VO1 is changed to the voltage of VB so that voltage levels of the electrodes VE1 and VO1 are different.

During M3, the switch SW3 remains turned on and the switch SW81 is also turned on. As a result, the voltage at the electrode VE1 maintains the voltage of VA. Also, as shown in FIG. 7C, a current path from the electrode VO1, to the inductor L2, the diode D61, the switch SW81, and the power source VC is formed to generate LC resonance, so that the voltage level of the electrode VO1 is decreased from the voltage of VA to the voltage of VB.

During M4, the switch SW2 is turned on and the voltage at the electrode VO1 becomes the voltage of VB. The voltage at the electrode VE1 maintains the voltage of VA because the switch SW3 has remained turned on. Because the voltages at the electrodes VO1 and VE1 are different, power is recovered between the electrodes VO1 and VE1 after M4.

During M5, the switch SW5 is turned on. As shown in FIG. 7E, a current path including the electrode VE1, the inductor L1, the diode D1, the switch SW5, and the electrode VO1 is formed that generates LC resonance. Accordingly, the voltage at the electrode VO1 is increased from the voltage of VB to the voltage of VA, and the voltage at the electrode VE1 is decreased from the voltage of VA to the voltage of VB.

During M6, the switches SW1 and SW4 are turned on. As shown in FIG. 7F, the voltages at the electrodes VO1 and VE1 respectively become the voltages of VA and VB.

During M7, the switch SW6 is turned on. As shown in FIG. 7G, a current path including the electrode VO1, the inductor L2, the diode D2, the switch SW6, and the electrode VE1 is formed that generates LC resonance. Accordingly, the voltage at the electrode VO1 is decreased from the voltage of VA to the voltage of VB, and the voltage at the electrode VE1 is increased from the voltage of VB to the voltage of VA.

Operations of M4 to M7 are repeated after M7. Voltages similar to the voltages applied to the electrodes VO1 and VE1 during M4 to M7, as shown in FIG. 6, are applied to the electrodes VO2 and VE2 during M4 to M7 as well. Hence, a sustain discharge voltage is applied between the electrodes VO1 and VO2 and between the electrodes VE1 and VE2 and power is recovered. This operation is well known to those skilled in the art and is disclosed in Korean Published Application No. 10-1999-0061691.

During M8, the switch SW72 is turned on while the switch SW1 remains on. As shown in FIG. 7H, a current path including the power source VC, the switch SW72, the diode D52, the inductor L1, and the electrode VE1 is formed that generates LC resonance. Accordingly, the voltage at the electrode VE1 is increased from the voltage of VB to the voltage of VA.

During M9, the switch SW3 is turned on while the switch SW1 remains on. As shown in FIG. 7I, the voltages at the electrodes VO1 and VE1 become the voltage of VA. As described above, the power recovery circuit according to the first embodiment of the present invention uses LC resonance when the voltages at the electrodes VO1 and VE1 are concurrently varied from the voltage of VB to the voltage of VA during M1, when the voltage levels at the electrodes VO1 and VE1 are varied from the same voltage level of VA to the different voltage levels of VB and VA during M3, and when the voltage levels at the electrodes VO1 and VE1 are varied from the different voltage levels of VB and VA to the same voltage level of VA during M8. By using the above LC resonance, power is recovered between the electrodes VO1 and VE1 when the electrodes have different voltage levels. Further, power is not consumed by hard switching.

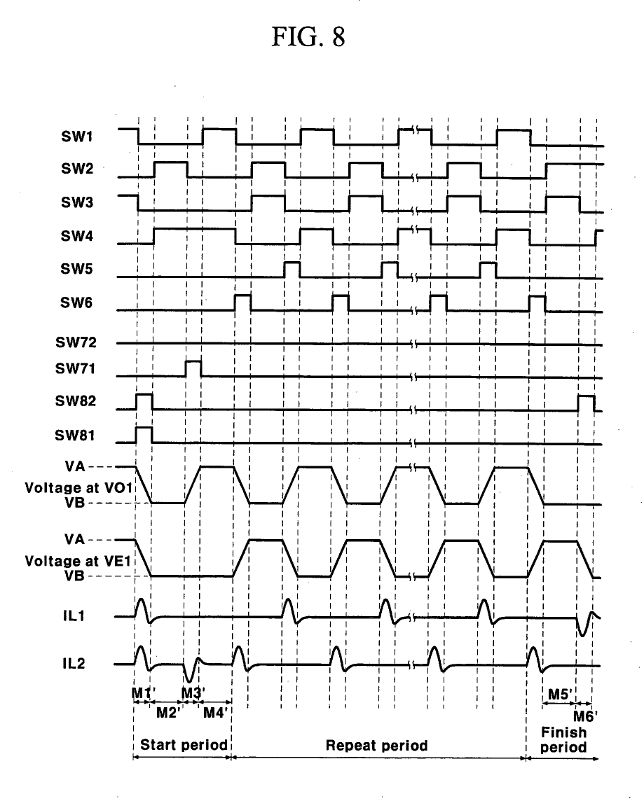

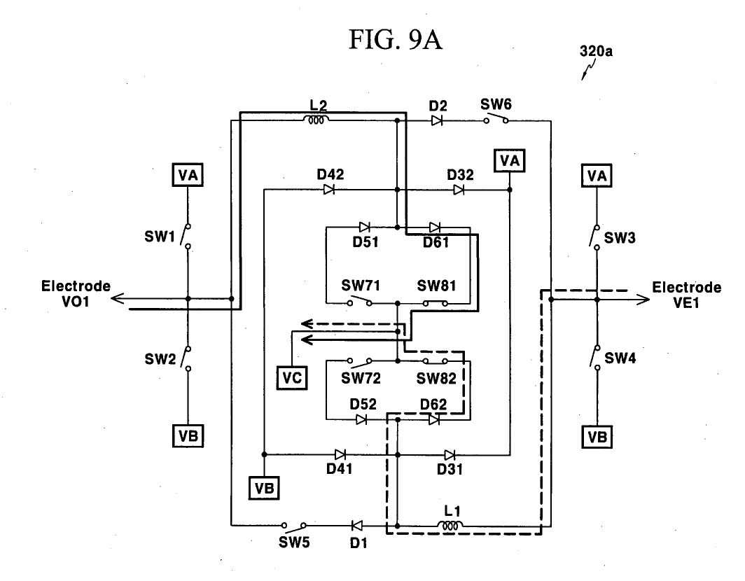

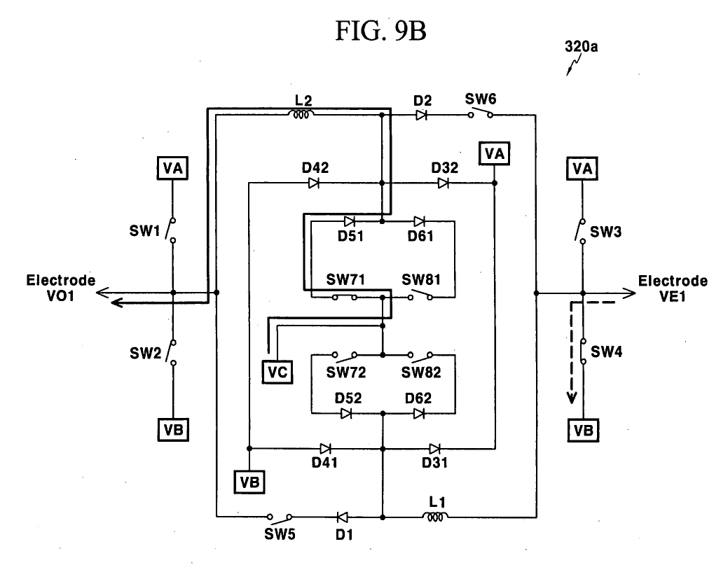

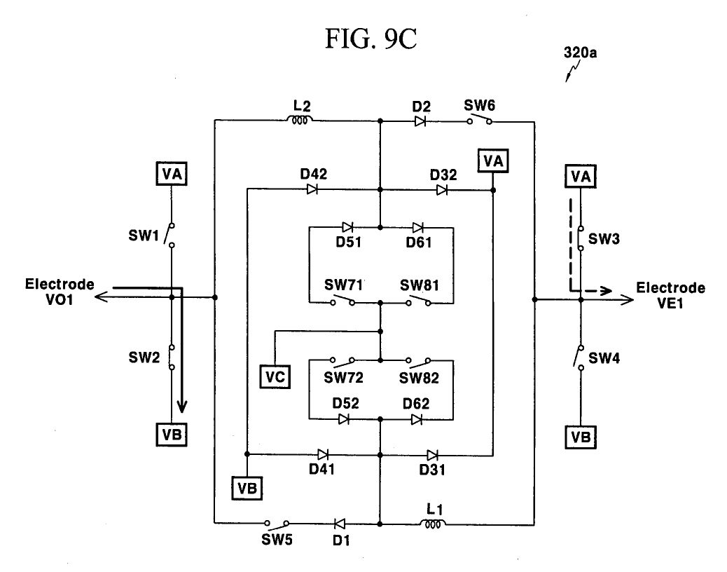

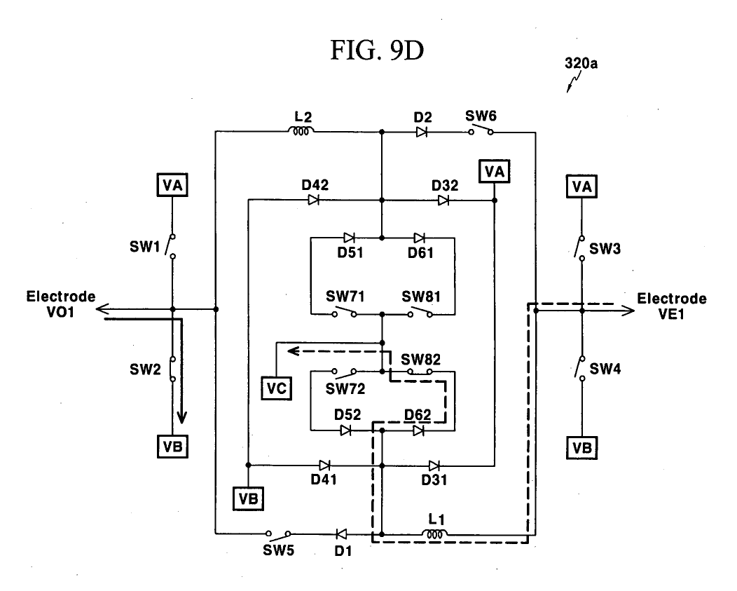

A method for power recovery, according to a second embodiment of the present invention, is described with reference to FIG. 8 and FIGS. 9A to 9D, where the voltage levels of the electrodes VO1 and VE1 are both at the same voltage level of VB at the end of the sustain period and both at the same voltage level of VA in the beginning of the sustain period.

FIG. 8 shows a second driving timing diagram of a power recovery circuit according to an exemplary embodiment of the present invention, and FIGS. 9A to 9D show current paths of various modes in the second driving timing diagram of FIG. 8. Power recovery of FIG. 8 is similar to power recovery of FIG. 6 except during the start period and the termination period, and hence, only the differences will be described. It is assumed that the voltages at the electrodes VO1 and VE1 before the start of the sustain period are at the voltage of VA. While FIGS. 9A, 9B, 9C, and 9D show the application of the voltage waveforms of FIG. 8 to electrodes VO1 and VE1 of the Y electrode driver 320a, the same waveforms may be applied to electrodes VO2 and VE2 of the X electrode driver 340.

The sustain period is divided into start, repeat, and finish periods. The start period is divided into four modes of mode one′ (M1′), mode two′ (M2′), mode three′ (M3′), and mode four′ (M4′). The finish period included mode five′ (M5′) and mode six′ (M6′).

During M1′, the switches SW81 and SW82 are turned on and the remaining switches are off. As shown in FIG. 9A, when the switch SW81 is turned on, a current path from the electrode VO1, to the inductor L2, the diode D61, the switch SW81, and the power source VC is formed that generates LC resonance, and the voltage at the electrode VO1 is decreased from the voltage of VA to the voltage of VB. When the switch SW82 is turned on, a current path from the electrode VE1, to the inductor L1, the diode D62, the switch SW82, and the power source VC is formed that generates LC resonance, and the voltage at the electrode VE1 is decreased from the voltage of VA to the voltage of VB.

During M2′, the switches SW2 and SW4 are turned on and the remaining switches are off. The voltages at the electrodes VO1 and VE1 become the voltage of VB. There are no current path figures corresponding to this mode.

During M3′, the switch SW71 is turned on while the switch SW4 remains on and other switches are off. As shown in FIG. 9B, a current path from the power source VC, to the switch SW71, the diode D51, the inductor L2, and the electrode VO1 is formed that generates LC resonance. The voltage at the electrode VO1 is increased from the voltage of VB to the voltage of VA. The voltage at the electrode VE1 maintains the voltage of VB because the switch SW4 remains on.

During M4′, the switch SW1 is turned on while the switch SW4 remains on and other switches are off. The voltage at the electrode VO1 maintains the voltage of VA. Accordingly, the voltages at the electrodes VO1 and VE1 respectively become the voltages of VA and VB, and power can then be recovered between the two electrodes VO1 and VE1. There are no current path figures corresponding to this mode.

During the repeat period, when the switch SW5 or SW6 is turned on, LC resonance is generated between the electrodes VO1 and VE1. A similar process was described with reference to FIG. 6 and will not be repeated below.

During M5′, the switches SW2 and SW3 are turned on while other switches are off. As shown in FIG. 9C, the voltage at the electrode VO1 becomes the voltage of VB, and voltage at the electrode VE1 becomes the voltage of VA.

During M6′, the switch SW82 is turned on while the switch SW2 remains on and other switches are off. The voltage at the electrode VO1 maintains the voltage of VB. As shown in FIG. 9D, when the switch SW82 is turned on, a current path from the electrode VE1, to the inductor L1, the diode D62, the switch SW82, and the power source VC is formed that generates LC resonance, and the voltage at the electrode VE1 is decreased from the voltage of VA to the voltage of VB.

During M6′, When the voltage at the electrode VE1 is substantially reduced to the voltage of VB, the switch SW4 is turned on and the voltage at the electrode VE1 remains at the voltage of VB. The electrodes VO1 and VE1 maintain the voltage of VB.

As described above, the power recovery circuit according to the second embodiment of the present invention uses LC resonance when the voltages at the electrodes VO1 and VE1 are concurrently varied from the voltage of VA to the voltage of VB during M1′, when the voltage levels at the electrodes VO1 and VE1 are varied from the same voltage level of VB to the different voltage levels of VA and VB during M3′, and when the voltage levels at the electrodes VO1 and VE1 are varied from the different voltage levels of VB and VA to the same voltage level of VB during M6′. By using the above-noted LC resonance, power is recovered between the electrodes VO1 and VE1 when the electrodes have different voltage levels, and power is not consumed by hard switching.

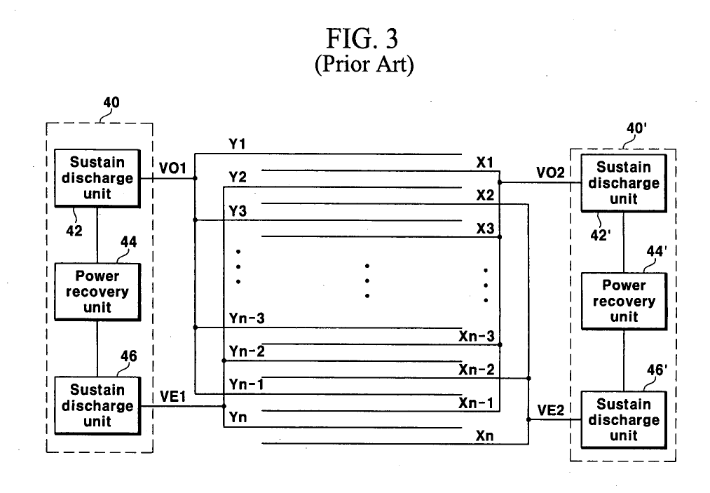

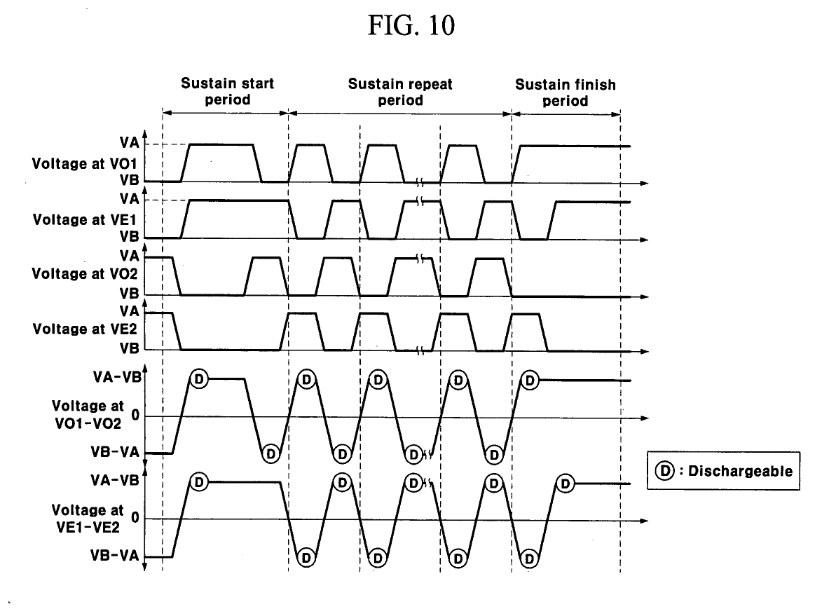

FIG. 10 shows a sustain discharge occurring between the electrodes VO1 and VO2 and between the electrodes VE1 and VE2, when voltage waveforms of the electrodes VO1 and VE1 shown in FIG. 6 are applied to the electrodes VO1 and VE1 shown in FIG. 3 and voltage waveforms of the electrodes VO1 and VE1 shown in FIG. 8 are applied to the electrodes VO2 and VE2 shown in FIG. 3.

As shown in FIG. 10, the voltage of VA-VB and the voltage of VB-VA are applied between the electrodes VO1 and VO2 to generate a sustain discharge. These voltages VA-VB and VB-VA are also applied between the electrodes VE1 and VE2 to generate a sustain discharge. That is, the waveforms during the sustain period are designed by applying the waveforms of FIG. 10 to the electrodes VO1, VO2, VE1, and VE2. In the exemplary embodiment shown, the sustain period has a sustain start period (corresponding to the start periods of FIG. 6 and FIG. 8), a sustain repeat period (corresponding to the repeat periods of FIG. 6 and FIG. 8), and a sustain finish period (corresponding to the finish periods of FIG. 6 and FIG. 8).

When the first power recovery circuit 320a of FIG. 5 is used to generate the voltage waveforms of the electrodes VO1 and VE1 shown in FIG. 6, the switches SW71 and SW72 can be combined into a single switch SW7 because they have the same function; the unused switch SW82 can be removed. As shown in FIG. 6, the switches SW71 and SW72 have the same switching operation except during M8. During this mode, the switch SW71 can be either turned on or off because the electrode VO1 maintains the voltage of VA during M8. Therefore, the switches SW71 and SW72 perform substantially the same switching operation. The switch SW82 can be removed because, as shown in FIG. 6, this switch is always turned off.

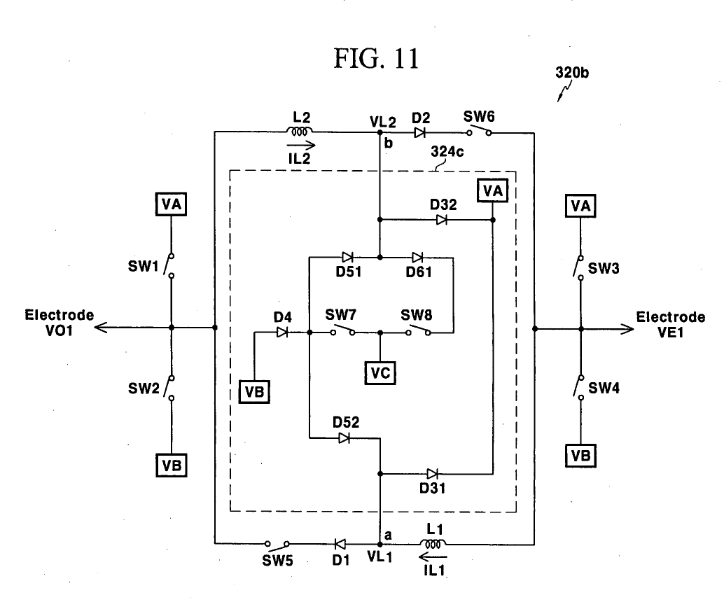

FIG. 11 shows a simplified second power recovery circuit 320b according to an exemplary embodiment of the present invention. As shown in FIG. 11, the second power recovery circuit 320b of the second embodiment is similar to the first power recovery circuit 320a except that the switches SW71 and SW72 are combined, the switch SW82 is removed, and SW81 is represented by SW8. Therefore, a repetitive description of this circuit is omitted.

The second power recovery circuit 320b includes a first clamping-VC connector 324c for clamping voltages VL1 and VL2 at the nodes “a” and “b”, and for recovering power when changing voltage levels of the electrodes VO1 and VE1 from the same level to different levels and from different levels to the same level. The first clamping-VC connector 324c is a first embodiment for a clamping-VC connector and is used in the second power recovery circuit 324b of FIG. 11.

The first clamping-VC connector 324c includes a diode D31, a diode D32, a diode D51, a diode D61, a diode D4, and a diode D52. The diode D31 has an anode coupled to the node “a” and a cathode coupled to the power source VA. The diode D32 has an anode coupled to the node “b” and a cathode coupled to the power source VA. The diode D51 has a cathode coupled to the node “b”. The switch SW7 is coupled between the anode formed between the diode D51 and the power source VC. The diode D61 has an anode coupled to the node “b”. The switch SW8 is coupled between the cathode of the diode D61 and the power source VC. The diode D4 has a cathode coupled to a node formed between the diode D51 and the switch SW7 and an anode coupled to the power source VB. The diode D52 has a cathode coupled to the node “a” and an anode coupled to the cathode of the diode D4. The diodes D32 and D31 prevent the voltages of VL1 and VL2 at the nodes “a” and “b” from being greater than the voltage of VA. Also, the diodes D4 and D51 prevent the voltage VL2 at the node “b” from being less than the voltage of VB, and the diodes D4 and D52 prevent the voltage VL1 at the node “a” from being less than the voltage of VB.

The switch SW7 and the diode D51 are used to increase the voltage at the electrode VO1 from the voltage of VB to the voltage of VA, and the switch SW8 and the diode D61 are used to decrease the voltage at the electrode VO1 from the voltage of VA to the voltage of VB. The switch SW7 and the diode D52 are used to increase the voltage at the electrode VE1 from the voltage of VB to the voltage of VA.

A method for applying the waveform of FIG. 6 to the electrodes VO1 and VO2 through the second power recovery circuit 320b of FIG. 11 is now described.

The switch SW7 is turned on during M1 of FIG. 6. A current path from the power source VC, to the switch SW7, the diode D51, the inductor L2, and the electrode VO1 is formed that generates LC resonance, and the voltage at the electrode VO1 is increased from the voltage of VB to the voltage of VA. Also, a current path from the power source VC, the switch SW7, the diode D52, the inductor L1, and the electrode VE1 is formed that generates LC resonance, and the voltage at the electrode VE1 is increased from the voltage of VB to the voltage of VA.

During M2 of FIG. 6, the switches SW1 and SW3 are turned on coupling the electrodes VO1 and VE1 to VA. During M3, the switch SW8 (shown as SW81 in FIG. 6) is turned on while the switch SW3 remains on. Hence, a current path from the electrode VO1, to the inductor L2, the diode D61, the switch SW8, and the power source VC is formed that generates LC resonance, and the voltage at the electrode VO1 is decreased from the voltage of VA to the voltage of VB. Operations during M4 to M7 correspond to operations of the first power recovery circuit 320a and their description is omitted.

During M8, the switch SW7, that now replaces the switch SW72, is turned on. A current path from the power source VC, to the switch SW7, the diode D52, the inductor L1, and the electrode VE1 is formed that generates LC resonance, and the voltage at the electrode VE1 is increased from the voltage of VB to the voltage of VA. No current path from the power source VC to the electrode VO1 is formed because the voltage at the electrode VO1 is higher than the voltage of VC when the switch SW7 is turned on, and hence the electrode VO1 maintains the voltage of VA.

During M9, the switch SW3 is turned on, the switch SW1 remains on, and the electrodes VO1 and VE1 maintain the voltage of VA. The voltage waveforms of the electrodes VO1 and VE1 shown in FIG. 6 are realized through the simplified second power recovery circuit 320b. When the voltage waveforms of the electrodes VO1 and VE1 shown in FIG. 8 are generated by using the first power recovery circuit 320a of FIG. 5, the switches SW81 and SW82 can be combined into a single switch SW8 because the switches SW81 and SW82 have the same function, and the unused switch SW72 can then be removed. As shown in FIG. 8, the switches SW81 and SW82 have the same switching operation except during M6′, and the switch SW81 can be turned on or off without impacting the circuit because the electrode VO1 maintains the voltage of VB during M6′. Therefore, the switches SW81 and SW82 perform substantially the same switching operation. The switch SW72 can be removed because this switch is always turned off without performing a switching operation as shown in FIG. 6.

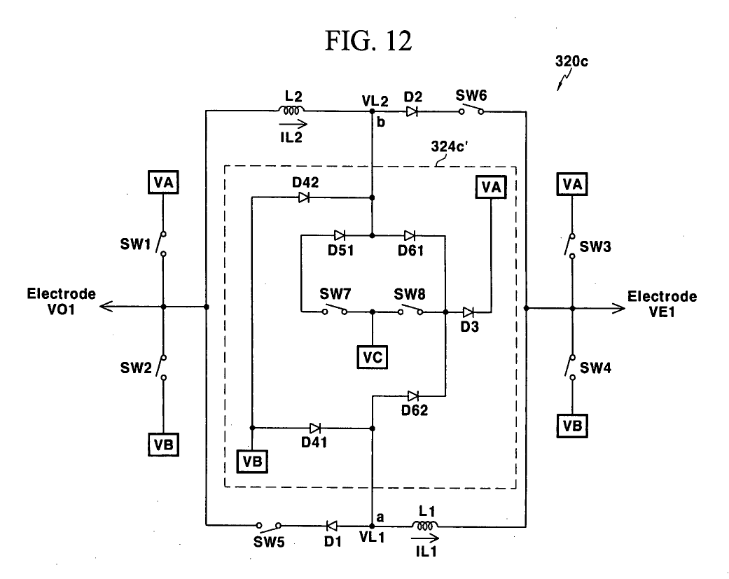

FIG. 12 shows a further simplified third power recovery circuit 320c according to an exemplary embodiment of the present invention. As shown in FIG. 12, the third power recovery circuit 320c is similar to the power recovery circuit according to the first embodiment 320a except that the switches SW81 and SW82 are combined into a switch SW8 and the switch SW72 is removed. The switch SW71 is shown with the notation SW7. A detailed description of the similar parts of the third power recovery circuit 320c is omitted.

The third power recovery circuit 320c includes a second clamping-VC connector 324c′ for clamping voltages VL1 and VL2 at the nodes “a” and “b”, and for recovering power when changing voltage levels of the electrodes VO1 and VE1 from the same level to different levels and from different levels to the same level. The second clamping-VC connector 324c′ is a second embodiment of the first clamping-VC connector 324c.

The second clamping-VC connector 324c′ includes a diode D41, a diode D42, a diode D51, a switch SW7, a diode D61, a switch SW8, a diode D3, and a diode D62. The diode D41 has a cathode coupled to the node “a” and an anode coupled to the power source VB. The diode D42 has a cathode coupled to the node “b” and an anode coupled to the power source VB. The diode D51 has a cathode coupled to the node “b”. The switch SW7 is coupled between the anode formed between the diode D51 and the power source VC. The diode D61 has an anode coupled to the node “b”. The switch SW8 is coupled between the cathode of the diode D61 and the power source VC. The diode D3 has an anode coupled to a node formed between the diode D61 and the switch SW8, and a cathode coupled to the power source VA. The diode D62 has an anode coupled to the node “a” and a cathode coupled to the anode of the diode D3. The diodes D41 and D42 prevent the voltages of VL1 and VL2 at the nodes “a” and “b” from being less than the voltage of VB. Also, the diodes D3 and D61 prevent the voltage VL2 at the node “b” from being greater than the voltage of VA, and the diodes D3 and D62 prevent the voltage VL1 at the node “a” from being greater than the voltage of VA.

The switch SW7 and the diode D51 are used to increase the voltage at the electrode VO1 from the voltage of VB to the voltage of VA, and the switch SW8 and the diode D61 are used to decrease the voltage at the electrode VO1 from the voltage of VA to the voltage of VB. The switch SW8 and the diode D62 are used to decrease the voltage at the electrode VE1 from the voltage of VA to the voltage of VB.

A method for applying the waveform of FIG. 8 to the electrodes VO1 and VO2 through the third power recovery circuit 320c of FIG. 12 according to the third embodiment is described below.

The switch SW8 is turned on during M1′ of FIG. 8. A current path from the electrode VO1, to the inductor L2, the diode D61, the switch SW8, and the power source VC is formed that generates LC resonance, and the voltage at the electrode VO1 is decreased from the voltage of VA to the voltage of VB. Also, a current path from the electrode VE1, to the inductor L1, the diode D62, the switch SW8, and the power source VC is formed that generates LC resonance, and the voltage at the electrode VE1 is decreased from the voltage of VA to the voltage of VB.

During M2′ of FIG. 8, the switches SW2 and SW4 are turned on. During M3′, the switch SW7 is turned on while the switch SW4 remains on, and hence, a current path from the power source VC, to the switch SW7, the diode D51, the inductor L2, and the electrode VO1 is formed that generates LC resonance, and hence, the voltage at the electrode VO1 is increased from the voltage of VB to the voltage of VA. Operations during M4′ and M5′ correspond to those according to the first embodiment of the present invention, and are not described.

During M6′, the switch SW8 is turned on instead of turning on the switch SW82. A current path from the electrode VE1, to the inductor L1, the diode D62, the switch SW8, and the power source VC is formed that generates LC resonance, and the voltage at the electrode VE1 is decreased from the voltage of VA to the voltage of VB. No current path from the electrode VO1 to the power source VC is formed because the voltage at the electrode VO1 is lower than the voltage of VC when the switch SW8 is turned on, and hence, the electrode VO1 maintains the voltage of VB. The voltage waveforms of the electrodes VO1 and VE1 shown in FIG. 8 are realized through the simplified power recovery circuit according to the third embodiment of the present invention.

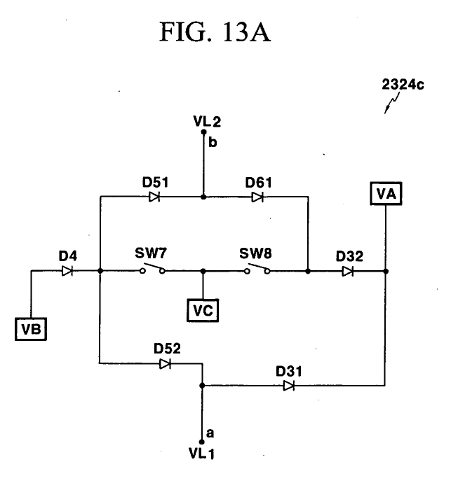

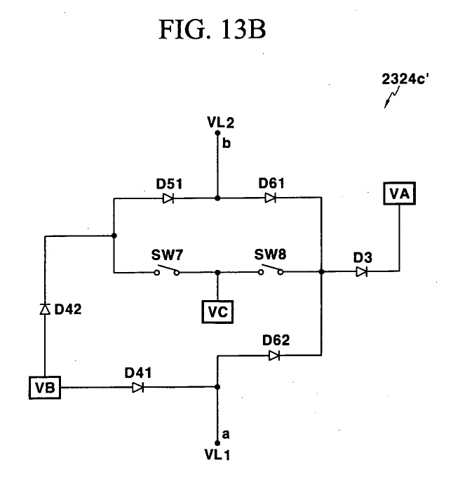

FIG. 13A shows a second clamping-VC connector 2324c of the second power recovery circuit 320b. FIG. 13B shows another embodiment 2324c′ of the second clamping-VC connector 324c′ of the power recovery circuit of the third embodiment 320c. FIG. 13A and FIG. 13B show clamping-VC connectors for ease of description, and the nodes “a” and “b” correspond to the nodes “a” and “b” of FIG. 11 and FIG. 12.

As shown in FIG. 13A, the clamping-VC connector 2324c includes a diode D31, a diode D52, a diode D4, a diode D51, a switch SW7, a diode D61, a switch SW8, and a diode D32. The diode D31 has an anode coupled to the node “a” and a cathode coupled to the power source VA. The diode D52 has a cathode coupled to the node “a”. The diode D4 has a cathode coupled to an anode of the diode D52 and an anode coupled to the power source VB. The diode D51 has a cathode coupled to the node “b” and an anode coupled to a node between the diodes D4 and D52. The switch SW7 is coupled between the anode of the diode D51 and the power source VC. The diode D61 has an anode coupled to the node “b”. The switch SW8 is coupled between the cathode of the diode D61 and the power source VC. The diode D32 has an anode coupled to a node between the diode D61 and the switch SW8 and a cathode coupled to the power source VA. The diodes D51 and D4 prevent the voltage of VL2 at the node “b” from being lower than the voltage of VB, and the diodes D4 and D52 prevent the voltage of VL1 at the node “a” from being lower than the voltage of VB. The diode D31 prevents the voltage of VL1 at the node “a” from being greater than the voltage of VA, and the diodes D32 and D61 prevent the voltage of VL2 at the node “b” from being greater than the voltage of VA. The operations of the switches SW7 and SW8 and the diodes D51 and D61 correspond to those of the second embodiment of the present invention, and are not described.

The circuit of FIG. 13A presents another embodiment 2324c for the first clamping-VC connector 324c that is used in the second power recovery circuit 320b of the present invention shown in FIG. 11. Except in the clamping-VC connector 2324c, the anode of the diode D32 is coupled to the cathode of the diode D61 and the cathode of the diode D32 is coupled to the power source VC so that the diodes D61 and D32 prevent the voltage VL2 at the node “b” from being greater than the voltage of VA.

The circuit of FIG. 13A presents another embodiment 2324c′ of the second clamping-VC connector 324c′ of the third power recovery circuit 320c shown in FIG. 12. Except in the clamping-VC connector 2324c′, the anode of the diode D42 is coupled to the power source VB and the cathode of this diode is coupled to the node formed between the diode D51 and the switch SW7. The diodes D42 and D51 prevent the voltage VL2 at the node “b” from being lower than the voltage of VB. Operations of the diodes D41, D51, D61, and D62 and the switches SW7 and SW8 correspond to those of the third power recovery circuit 320c, and are not described.

As described above, power consumption is reduced by recovering power in the power recovery circuit by using a panel capacitor to recover power when the voltages at the two electrodes VO1 and VE1 are changed from the same voltage level to different voltage levels, and vice versa. Also, the circuit is simplified by combining elements which perform common functions.

The voltage levels of the electrodes VO1 and VO2 are controlled to be different through power recovery using a VC connector, and power consumption is reduced to satisfy the initial condition of the serial CLC resonance power recovery circuit, namely, that the electrodes VO1 and VE1 have different voltage levels. Also, power consumption is further reduced by using the VC connector to control the different voltage levels of the two electrodes VO1 and VE1 to be the same.

The voltage levels of the two electrodes VO1 and VE1 are the same when the period is changed from the address period to the sustain period, and the voltage levels of the two electrodes are different when the period is changed from the last sustain pulse of the sustain period to the reset period. As a result, the same voltage level is changed to different voltage levels, and vice versa, when the VC connector is operated to recover power by LC resonance.

The power recovery circuit is applicable to the parallel LC resonance type circuits and the serial LCLC resonance type circuits as well as the serial CLC resonance type circuits. That is, power consumption is reduced by using the above-described power recovery circuit when the capacitive load of a PDP is used in the power recovery circuit. Also, it has been assumed for ease of description in the above descriptions that the electrode VO1 is coupled to odd-line scan electrodes from among the scan electrodes Y1 to Yn, and the electrode VE1 is coupled to even-line scan electrodes. However, it is also possible to couple the electrode VO1 to any part of the scan electrodes Y1 to Yn, and the electrode VE1 to residual electrodes. The switches SW1 to SW82 are realized by MOSFETs, although other types of transistors may also be used.

While this invention has been described in connection with what is presently considered to be practical exemplary embodiments. It is to be understood that the invention is not limited to the disclosed embodiments, but on the contrary, is intended to cover various modifications and equivalent arrangements included within the spirit and scope of the appended claims.

What is claimed is:

1. A plasma display device comprising:
a panel including a plurality of first electrodes and second electrodes; and
a driving circuit for using a first panel capacitor and a second panel capacitor formed respectively at a first electrode and a second electrode to form a charge and discharge path between the first electrode and the second electrode,
wherein the driving circuit includes:
a first inductor having a first terminal coupled to the first electrode;
a first switch coupled between a second terminal of the first inductor and the second electrode for switching a charge path from the first electrode to the second electrode;
a second inductor having a first terminal coupled to the second electrode;
a second switch coupled between a second terminal of the second inductor and the first electrode for switching a charge path from the second electrode to the first electrode;
a third switch coupled between the second terminal of the second inductor and a first power source for supplying a first voltage for switching a charge path from the first power source to the second electrode; and
a fourth switch coupled between the second terminal of the second inductor and the first power source for switching a path for discharging the second electrode.

2. The plasma display device of claim 1, wherein the driving circuit further comprises:
a fifth switch coupled between the second terminal of the first inductor and the first power source for switching a charge path from the first power source to the first electrode; and
a sixth switch coupled between the second terminal of the first inductor and the first power source for switching a path for discharging the first electrode.

3. The plasma display device of claim 2, wherein the driving circuit further comprises:
a first diode having a cathode coupled to the second terminal of the second inductor and an anode coupled to the third switch; and
a second diode having an anode coupled to the second terminal of the second inductor and a cathode coupled to the fourth switch.

4. The plasma display device of claim 3, wherein the driving circuit further comprises:
a third diode having a cathode coupled to the second terminal of the first inductor and an anode coupled to the fifth switch; and
a fourth diode having an anode coupled to the second terminal of the first inductor and a cathode coupled to the sixth switch.

5. The plasma display device of claim 1, wherein:
when the third switch is turned on, a current path including the first power source, the third switch, the second inductor, and the second electrode is formed, and the voltage at the second electrode is increased from a second voltage that is less than the first voltage to a third voltage that is greater than the first voltage, and
when the fourth switch is turned on, a current path including the second electrode, the second inductor, the fourth switch, and the first power source is formed, and the voltage at the second electrode is decreased from the third voltage to the second voltage.

6. The plasma display device of claim 2, wherein:
when the fifth switch is turned on, a current path including the first power source, the fifth switch, the first inductor, and the first electrode is formed, and the voltage at the first electrode is increased from a second voltage that is less than the first voltage to a third voltage that is greater than the first voltage, and
when the sixth switch is turned on, a current path including the first electrode, the first inductor, the sixth switch, and the first power source is formed, and the voltage at the first electrode is decreased from the third voltage to the first voltage.

7. The plasma display device of claim 1, wherein the third switch is turned on in an early stage of a sustain period or in a latter stage of the sustain period, and the fourth switch is turned on in the early stage of the sustain period or in the latter stage thereof.

8. The plasma display device of claim 2, wherein the fifth switch is turned on in an early stage of the sustain period or in the latter stage of the sustain period, and the sixth switch is turned on in the early stage of the sustain period or in the latter stage thereof.

9. The plasma display device of claim 4, wherein the driving circuit further comprises:
a fifth diode having an anode coupled to the second terminal of the first inductor and a cathode coupled to a third power source for supplying a third voltage which is greater than the first voltage;
a sixth diode having an anode coupled to the second terminal of the second inductor and a cathode coupled to the third power source;
a seventh diode having a cathode coupled to the second terminal of the first inductor and an anode coupled to a second power source for supplying a second voltage that is less than the first voltage; and
an eighth diode having a cathode coupled to the second terminal of the second inductor and an anode coupled to the second power source.

10. The plasma display device of claim 9, wherein the driving circuit further comprises:
a ninth diode having an anode coupled to the second terminal of the first inductor and a cathode coupled to the first switch; and
a tenth diode having an anode coupled to the second terminal of the second inductor and a cathode coupled to the second switch.

11. The plasma display device of claim 1, wherein the driving circuit further comprises a first diode having a cathode coupled to the second terminal of the first inductor and an anode coupled to the third switch.

12. The plasma display device of claim 11, wherein:
the voltages at the first electrode and the second electrode are increased from a second voltage that is less than the first voltage to a third voltage that is greater than the first voltage in an early stage of a sustain period when the third switch is turned on, and
the voltage at the second electrode is decreased from the third voltage to the second voltage when the third switch is turned on again in a latter stage of the sustain period.

13. The plasma display device of claim 11, wherein the driving circuit further comprises:
a second diode having a cathode coupled to the second terminal of the second inductor and an anode coupled to the third switch;
a third diode having an anode coupled to the second terminal of the second inductor and a cathode coupled to the third switch;
a fourth diode having a cathode coupled to a node between the first diode and the second diode and an anode coupled to a second power source for supplying a second voltage that is less than the first voltage;
a fifth diode having an anode coupled to the second terminal of the first inductor and a cathode coupled to a third power source for supplying a third voltage that is greater than the first voltage; and
a sixth diode having an anode coupled to the second terminal of the second inductor and a cathode coupled to the third power source.

14. The plasma display device of claim 1, wherein the driving circuit further comprises:
a first diode having a cathode coupled to the second terminal of the first inductor and an anode coupled to a second power source for supplying a second voltage that is less than the first voltage;
a second diode having a cathode coupled to the second terminal of the second inductor and an anode coupled to the third switch;
a third diode having an anode coupled to the second terminal of the second inductor and a cathode coupled to the third switch;
a fourth diode having a cathode coupled to a node between the third diode and the second diode and an anode coupled to the second power source;
a fifth diode having an anode coupled to the second terminal of the first inductor and a cathode coupled to a third power source for supplying a third voltage that is greater than the first voltage; and
a sixth diode having an anode coupled to the cathode of the third diode and a cathode coupled to the third power source.

15. The plasma display device of claim 1, wherein the driving circuit further comprises a first diode having an anode coupled to the second terminal of the first inductor and a cathode coupled to the fourth switch.

16. The plasma display device of claim 15, wherein:
the voltages at the first electrode and the second electrode are decreased from a third voltage that is greater than the first voltage to a second voltage that is less than the first voltage in a former stage of a sustain period when the fourth switch is turned on, and
the voltage at the second electrode is increased from the second voltage to the third voltage when the fourth switch is turned on again in a latter stage of the sustain period.

17. The plasma display device of claim 15, wherein the driving circuit further comprises:
a second diode having a cathode coupled to the second terminal of the second inductor and an anode coupled to the third switch;
a third diode having an anode coupled to the second terminal of the second inductor and a cathode coupled to the fourth switch;
a fourth diode having an anode coupled to a node between the third diode and the fourth switch and a cathode coupled to a third power source for supplying a third voltage that is greater than the first voltage;
a fifth diode having a cathode coupled to the second terminal of the first inductor and an anode coupled to a second power source for supplying a second voltage that is less than the first voltage; and
a sixth diode having a cathode coupled to the second terminal of the second inductor and an anode coupled to the second power source.

18. The plasma display device of claim 15, wherein the driving circuit further comprises:
a second diode having a cathode coupled to the second terminal of the second inductor and an anode coupled to the third switch;
a third diode having an anode coupled to the second terminal of the second inductor and a cathode coupled to the fourth switch;
a fourth diode having an anode coupled to a node between the first diode and the third diode and a cathode coupled to a third power source for supplying a third voltage that is greater than the first voltage;
a fifth diode having a cathode coupled to the second terminal of the first inductor and an anode coupled to a second power source for supplying a second voltage that is less than the first voltage; and
a sixth diode having a cathode coupled to the anode of the second diode and an anode coupled to the second power source.

19. The plasma display device of claim 1, wherein the first electrode and the second electrode include scan electrodes.

20. A plasma display device driving method for using a driving circuit, a first panel capacitor, and a second panel capacitor, and forming a charge/discharge path between a first electrode and a second electrode, the driving circuit including a first inductor having a first terminal coupled to the first electrode and a second inductor having a first terminal coupled to the second electrode, the first panel capacitor being formed at the first electrode, and the second panel capacitor being formed at the second electrode, the method comprising:
turning on a first switch coupled to a second terminal of the second inductor in an early stage of a sustain period, and changing voltage levels of the first electrode and the second electrode from a same voltage level to different voltage levels; and
alternately turning on a second switch coupled between a second terminal of the first inductor and the second electrode and a third switch coupled between a second terminal of the second inductor and the first electrode, and forming a charge/discharge path between the first electrode and second electrodes.

21. The plasma display device driving method of claim 20, further comprising:
turning on a fourth switch coupled to the second terminal of the first inductor in a latter stage of the sustain period, and changing voltage levels of the first electrode and the second electrode from different voltage levels to a same voltage level.

22. The plasma display device driving method of claim 20, wherein:
the driving circuit further comprises a diode having an anode coupled to the second terminal of the second inductor and a cathode coupled to the first switch, and
the turning on of a first switch further comprises:
forming a current path including the second electrode, the second inductor, the diode, the first switch, and a first power source for supplying a first voltage that is less than a third voltage for decreasing the voltage at the second electrode from the third voltage to a second voltage that is less than the first voltage, and
changing a voltage level of the first and second electrodes to different voltage levels, when the first switch is turned on while the first electrode is maintained at the third voltage.

23. The plasma display device driving method of claim 20, wherein:
the driving circuit further comprises a diode having a cathode coupled to the second terminal of the second inductor and an anode coupled to the first switch, and
the turning on of a first switch further comprises:
forming a current path including a first power source for supplying a first voltage that is greater than a second voltage, the first switch, the second inductor, and the second electrode for increasing the voltage at the second electrode to a third voltage that is greater than the first voltage, and
changing a voltage level of the first and second electrodes to different voltage levels, when the first switch is turned on while the first electrode is maintained at the second voltage.

24. The plasma display device driving method of claim 21, wherein:
the driving circuit further comprises a diode having a cathode coupled to the second terminal of the first inductor and an anode coupled to the fourth switch, and
the turning on a fourth switch further comprises:
forming a current path including a first power source for supplying a first voltage that is less than a third voltage, the fourth switch, the diode, the first inductor, and the first electrode for increasing the voltage at the first electrode from a second voltage, which is less than the third voltage, to the first voltage, and
changing a voltage level of the first electrode and the second electrode to a same voltage level, when the fourth switch is turned on while the second electrode is maintained at the second voltage.

25. The plasma display device driving method of claim 21, wherein:
the driving circuit further comprises a diode having an anode coupled to the second terminal of the first inductor and a cathode coupled to the fourth switch, and
the turning on a fourth switch further comprises:
forming a current path including the first electrode, the first inductor, the diode, the fourth switch, and a first power source for supplying a first voltage that is greater than a second voltage for decreasing the voltage at the first electrode from a third voltage, which is greater than the first voltage, to the first voltage, and
changing a voltage level of the first electrode and the second electrode to a same voltage level, when the fourth switch is turned on while the second electrode is maintained at the second voltage.

26. A driving method for power recovery from a panel capacitor in a plasma display panel, the panel including groups of electrodes of a same type and groups of electrodes of different types, the panel capacitor being formed between electrodes of different types, and power recovery being performed between electrodes of the same type, the method comprising:
generating a voltage difference between two groups of electrodes of the same type during an initial period of a sustain period;
establishing a resonance between the two groups of electrodes of the same type during the sustain period; and
generating equal voltages at the two groups of electrodes of the same type during a final period of a sustain period.

27. The method of claim 26, wherein the two groups of electrodes of the same type are at a same low voltage before start of the sustain period.

28. The method of claim 26, wherein the two groups of electrodes of the same type are at a same high voltage before start of the sustain period.

29. A power recovery circuit for a plasma display panel, the panel including groups of electrodes of a first type and groups of electrodes of a second type, panel capacitors formed between electrodes of the first type and the electrodes of the second type, the panel being driven during frames of time, each frame being divided into periods including a sustain period when a sustained discharge between the electrodes of the first type and the electrodes of the second type displays an image, the power recovery circuit comprising:
a first switch coupling a first group of electrodes of the first type to a positive sustain voltage;
a second switch coupling a second group of electrodes of the first type to a negative sustain voltage;
an inductor circuit coupled in series between the first group of electrodes of the first type and the second group of electrodes of the first type; and
a connector voltage circuit coupling the inductor circuits to a connector voltage higher than the negative sustain voltage and lower than the positive sustain voltage,
wherein the connector voltage circuit establishes a resonance in the inductor circuit between the first group of electrodes of the first type and the second group of electrodes of the first type by differentiating a voltage at the first group of electrodes of the first type from a voltage at the second group of electrodes of the first type during a start period of the sustain period, and
wherein the connector voltage circuit brings the voltage at the first group of electrodes of the first type and the voltage at the second group of electrodes of the first type back to a same level at completion of the sustain period.

30. The circuit of claim 29,
a third switch coupling a first group of electrodes of the second type to the positive sustain voltage;
a fourth switch coupling a second group of electrodes of the second type to the negative sustain voltage;
a second inductor circuit coupled in series between the first group of electrodes of the second type and the second group of electrodes of the second type; and
a second connector voltage circuit coupling the second inductor circuit to a connector voltage higher than the negative sustain voltage and lower than the positive sustain voltage,
wherein the second connector voltage circuit establishes a resonance in the inductor circuits between the first group of electrodes of the second type and the second group of electrodes of the second type by differentiating a voltage at the first group of electrodes of the second type from a voltage at the second group of electrodes of the second type during a start period of the sustain period, and
wherein the second connector voltage circuit brings the voltage at the first group of electrodes of the second type and the voltage at the second group of electrodes of the second type back to a same level at completion of the sustain period.
